(19) United States
(12) Patent Application Publication
(10) Pub. No.: US 2012/0066453 A1
(43) Pub. Date: Mar. 15, 2012

(54) CARD-READING DEVICE FOR MULTI CARDS

(75) Inventor: Ching-Wei Cheng, Keelung (TW)

(73) Assignee: ACTION STAR ENTERPRISE CO., LTD., Sijhih (TW)

(21) Appl. No.: 12/879,118

(22) Filed: Sep. 10, 2010

(51) Int. Cl. G06F 12/00

(52) U.S. Cl. 711/115; 711/E12.001

(57) ABSTRACT

The present invention relates to a card-reading device for multiple cards, which is adapted for inserting a plurality of memory cards, so as to access the plurality of memory cards, the card-reading device comprises: a connecting unit, a reading unit, a micro control unit (MCU), a plurality of switch unit, and a plurality of slots. Wherein the reading unit is able to directly access the first memory card M1 through the first switch unit when a first memory card is inserted into the first slot, in the meantime, when other memory cards are respectively inserted into the corresponding slots thereof, the reading unit can still directly access the first memory card, moreover, by way of the other switch unit except the first switch unit, the micro unit is able to access the memory cards except the first memory card.

### BACKGROUND OF THE INVENTION

1. Technical Field

The present invention relates to a card-reading device for a memory card, and more particularly, to a card-reading device for multi cards, which has multi slots and capable of simultaneously accessing multi memory cards.

2. Description of Related Art

With the development of storage medium, a memory card having high capacity and plug-and-play function gradually becomes the most popular storage media. There are wide types of the commercial memory cards, such as Compact Flash Card (CF card), McroDrive card (MD card), Secure Digital card (SD card), MultiMedia card (MMC card), Memory Stick card (MS card), or Smart Media card (SM card), etc.

For the memory cards are extensively used, a card-reading devices also become one kind of the necessary peripheral devices of a computer. With the different types of memory cards, the card-reading devices are correspondingly designed to be different forms. Please referring to FIG. 1, which illustrates a stereo view of the card-reading device for an SD card, as shown in FIG. 1, the card-reading device 1′ includes a body 11′ and a USB connector 12′, wherein one end of the body 11′ has a slot 111′, and another end of the body 11′ is connected to the USB connector 12′. The SD card 2′ can be inserted into a USB slot in the computer, so as to access the SD card 2′ through the computer.

The above-mentioned card-reading device 1′ for the SD card 2′ is a portable and plug-and-play device; however, it is merely applicable to the SD card 2′ and not appropriate for other types of memory cards. Assuredly, there are many kinds of the commercial card-reading devices applicable to access the corresponding memory cards thereof, but those commercial card-reading devices are still appropriate for single type of the memory card, respectively. Accordingly, the computer venders propose a card-reading device assembly. Referring to FIG. 2, which illustrates the stereo view of the card-reading device assembly and a host. As shown in FIG. 2, the card-reading device assembly 4′ may be disposed in a device slot 31′ of the host 3′. The card-reading device assembly 4′ includes a first card slot 41′ and a second card slot 42′, wherein the first card slot 41′ is for inserting memory cards 5′, and the second card slot 42′ is for inserting a specific type of the memory card. Opposing to the card-reading device 1′ described above, the card-reading device assembly 4′ is able to access multi types of memory card although it is un-portable.

For the commercial card-reading assembly 4′, the first card slot 41′ is designed to be inserted many types of the memory cards; however, nowadays, the user has been accustomed to use the same brand's 3C products, such as notebook, mobile phone, digital camera, multimedia player, etc., and the memory cards of the 3C products of the same brand are the same type, for example, SD card. Thus, the user may need to simultaneously to access multiple SD cards. However, the above-mentioned commercial card-reading assembly 4′ can not access two the same types of the memory cards that brings about the inconvenience for the user.

Accordingly, in view of the drawbacks and shortcomings of the card-reading device and the card-reading device assembly, the inventor of the present application has made great efforts to make inventive research thereon and eventually provided a card-reading device for multi cards according to the present invention.

### BRIEF SUMMARY OF THE INVENTION

The primary objective of the present invention is to provide a card-reading device for multi cards, which has multi slots and capable of accessing multi memory cards by means of a reading unit and a micro unit at the same time.

The second objective of the present invention is to provide a card-reading device for multi cards, which has multi slots and capable of simultaneously accessing multi memory cards by way of a reading unit and a micro unit.

The third objective of the present invention is to provide a card-reading device for multi cards, which has multi slots and capable of simultaneously accessing multi memory cards by way of a reading unit and a micro unit.

The fourth objective of the present invention is to provide a card-reading device for multi cards, which has multi slots and capable of simultaneously accessing multi memory cards by way of a reading unit and a micro unit.

Accordingly, to achieve the abovementioned primary objective, the inventor proposes a card-reading device for multi cards, which can be inserted a plurality of memory cards and accesses the plurality of memory cards at the same time, the card-reading device comprising: a connecting unit connected to a computer; a reading unit connected to the connecting unit; a micro control unit connected to the reading unit; a plurality of switch units connected to the reading unit and the micro control unit; and a plurality of slots respectively connected to the plurality of switch units for inserting the memory cards. Wherein a first slot electrically connects to a first switch unit when a first memory card is inserted into the first slot, then the reading unit is able to directly access the first memory card through the first switch unit, in the meantime, when other memory cards are respectively inserted into corresponding slots thereof, the slots electrically connect to the corresponding switch units thereof, such that the reading unit can still directly access the first memory card, moreover, by way of the other switch unit except the first switch unit, the micro unit is able to access the memory cards except the first memory card.

Moreover, to achieve the second objective described above, the inventor proposes a card-reading device for multi cards, which can be inserted a plurality of memory cards and accesses the plurality of memory cards at the same time, the card-reading device comprising: a connecting unit connected to a computer; a reading unit connected to the connecting unit; a micro control unit connected to the reading unit; a plurality of switch units connected to the reading unit; and a plurality of slots respectively connected to the plurality of switch units for inserting the memory cards, moreover, the plurality of slots also connect to the micro control unit. Wherein a first slot electrically connects to a first switch unit when a first memory card is inserted into the first slot, then the reading unit is able to directly access the first memory card through the first switch unit, in the meantime, when other memory cards are respectively inserted into the corresponding slots thereof, the slots electrically connect to the corresponding switch units thereof, such that the reading unit can still directly access the first memory card, and the micro unit is able to access the memory cards except the first memory card.

For achieving the third objective described above, the inventor proposes a card-reading device for multi cards, which can be inserted a plurality of memory cards and accesses the plurality of memory cards at the same time, the card-reading device comprising: a connecting unit connected to a computer; a reading unit connected to the connecting unit; a micro control unit connected to the reading unit; a plurality of multi-port switch units connected to the reading unit; and a plurality of slots respectively connected to the plurality of switch units by pair and adapted for inserting the memory cards, moreover, the plurality of slots also connect to the micro control unit. Wherein a first slot electrically connects to a first multi-port switch unit when a first memory card is inserted into the first slot, and then the reading unit is able to directly access the first memory card through the first multi-port switch unit, in the meantime, when other memory cards are respectively inserted into the corresponding slots thereof, the slots electrically connect to the corresponding multi-port switch units thereof, such that the reading unit can still directly access the first memory card, and the micro unit is able to access the memory cards except the first memory card.

For achieving the fourth objective described above, the inventor proposes a card-reading device for multi cards, which can be inserted a plurality of memory cards and accesses the plurality of memory cards at the same time, the card-reading device comprising: a connecting unit connected to a computer; a reading unit connected to the connecting unit; a micro control unit connected to the reading unit; a complex programmable logic unit connected to the reading unit and the micro control unit; and a plurality of slots connected to the complex programmable logic unit for inserting the memory cards. Wherein a first slot electrically connects to the complex programmable logic unit when a first memory card is inserted into the first slot, and then the reading unit is able to directly access the first memory card through the complex programmable logic unit, in the meantime, when other memory cards are respectively inserted into the corresponding slots thereof, the slots also electrically connect to the complex programmable logic unit, such that the reading unit can still directly access the first memory card, and the micro unit is able to access the memory cards except the first memory card by way of the complex programmable logic unit.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1 is a stereo view of a card-reading device for an SD card;

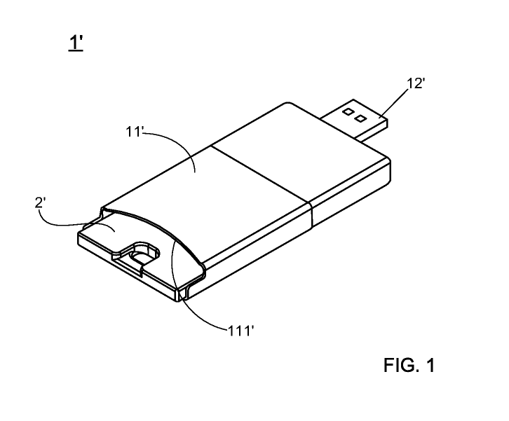

FIG. 2 is the stereo view of an improved card-reading device and a computer;

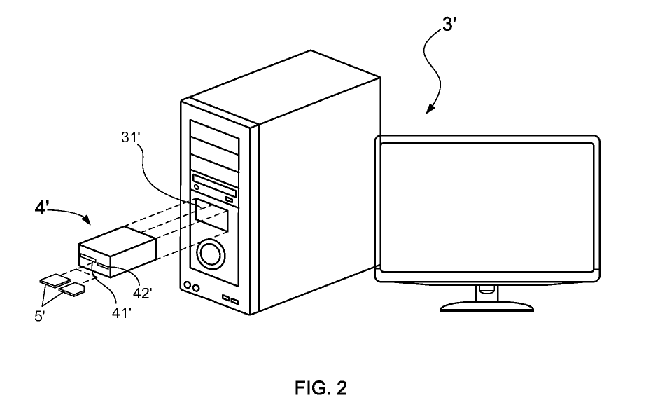

FIG. 3 is a first practicable framework of a card-reading device for multi card according to the present invention;

FIG. 4 is a second practicable framework of the card-reading device for multi card according to the present invention;

FIG. 5 is a third practicable framework of the card-reading device for multi card according to the present invention; and

FIG. 6 is a fourth practicable framework of the card-reading device for multi card according to the present invention.

### DETAILED DESCRIPTION OF THE INVENTION

To more clearly describe a card-reading device for multi cards according to the present invention, an embodiment of the present invention will be described in detail with reference to the attached drawings hereinafter.

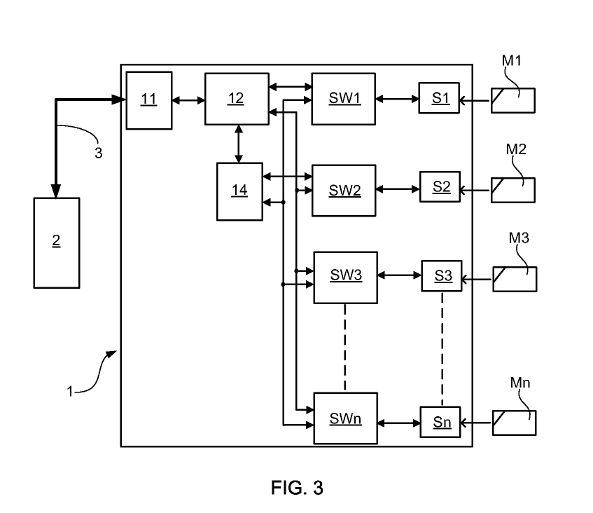

The card-reading device for multi cards has four practicable frameworks. Please referring to FIG. 3, which illustrates a first practicable framework of the card-reading device for multi card according to the present invention, as shown in FIG. 3, the card-reading device for multi cards 1 can be inserted a plurality of memory cards (M1, M2, M3, Mn), wherein the plurality of memory cards are the same type, so that a user is able to access the plurality of memory cards (M1, M2, M3, Mn) at the same time, the first practicable framework of the card-reading device 1 includes: a connecting unit 11, a reading unit 12, a micro control (MCU) unit 14, a plurality of switch unit (SW1, SW2, SW3, SWn), and a plurality of slots (S1, S2, S3, Sn)

As shown in FIG. 3, the connecting unit 11 is connected to a computer 2 via a transmission line 3, the reading unit 12 is connected to the connecting unit 12, and the micro control unit 14 is connected to the reading unit 12. The plurality of switch units (SW1, SW2, SW3, SWn) are connected to the reading unit 12 and the micro control unit 14, and the plurality of slots (S1, S2, S3, Sn) are respectively connected to the plurality of switch units (SW1, SW2, SW3, SWn) for inserting the memory cards. wherein a first slot S1 electrically connects to a first switch unit SW1 when a first memory card M1 is inserted into the first slot S1, then the reading unit 12 is able to directly access the first memory card M1 through the first switch unit SW1; When other memory cards (M2, M3, Mn) are respectively inserted into corresponding slots (S2, S3, Sn) thereof, the slots (S2, S3, Sn) electrically connect to the corresponding switch units (SW2, SW3, SWn) thereof, In the meantime, the reading unit 12 can still directly access the first memory card M1, moreover, by way of the other switch unit except the first switch unit SW1 (as shown in FIG. 3, i.e., a second switch unit SW2, a third switch unit SW3 and an Nth switch unit SWn), the micro unit 14 being able to access the memory cards except the first memory card M1 (as shown in FIG. 3, i.e., a second memory card M2, a third memory card M3 and an Nth memory card Mn).

In the first practicable framework of the card-reading device 1, the reading unit 12 and the micro control unit 14 are connected each other, and after the first memory card M1 is inserted into the corresponding first slot S1, the first switch unit SW1 switches for connecting the first slot S1 to the reading unit 12, so that, the user can operate the computer 2 for accessing the first memory card M1 via the reading unit 12. Furthermore, when the first memory card M1 is still inserted in the first slot S1, meanwhile, if the second memory card M2 is inserted into a corresponding second slot S2 as well as the third memory card M3 and the Nth memory card Mn are respectively inserted into a third slot S3 and an Nth slot Sn, the user is able to activate the micro control unit 14 via the reading unit 12 so as to make the micro control unit 14 to respectively access the second memory card M2, the third memory card M3 and the Nth memory card Mn through the second switch unit SW2, the third switch unit SW3 and the Nth switch unit SWn.

The card-reading device 1 is not only connected to the computer 2 through the transmission line 3 but also can be embedded into the computer 2 for accessing the memory cards. In the above mention, the first practicable framework of the card reading device for multi cards 1 has been complete described, and then a second practicable framework of the card reading device 1 will be disclosed.

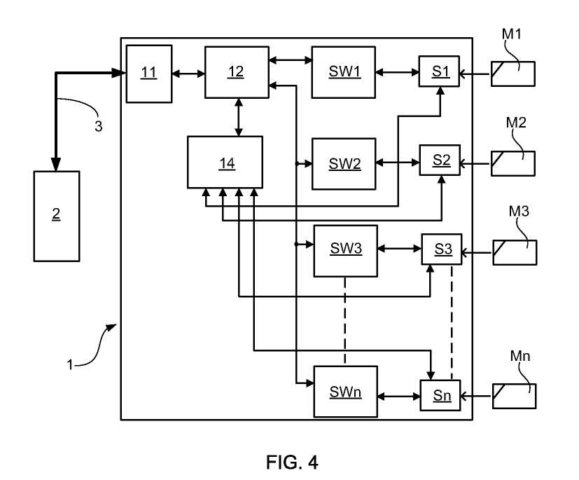

Please referring to FIG. 4, which illustrates the second practicable framework of the card-reading device for multi card according to the present invention, as shown in FIG. 4, actually, the members included in the second practicable framework of the card-reading device 1 are the same to the members included in the first practicable framework of the card-reading device 1, the second practicable framework of the card-reading device 1 includes: the connecting unit 11, the reading unit 12, the micro control unit (MCU) 14, the plurality of switch units (SW1, SW2, SW3, SWn), and the plurality of slots (S1, S2, S3, Sn)

Continuously referring to FIG. 4, in the second practicable framework of the card-reading device 1, the connecting unit 11 is connected to the computer 2 via the transmission line 3, the reading unit 12 is connected to the connecting unit 11, and the micro control unit 14 is connected to the reading unit 12. The plurality of switch units (SW1, SW2, SW3, SWn) are connected to the reading unit 12, and the plurality of slots (S1, S2, S3, Sn) are respectively connected to the plurality of switch units (SW1, SW2, SW3, SWn) for inserting the memory cards, moreover, the plurality of slots (S1, S2, S3, Sn) also connecting to the micro control unit 14.

In the second practicable framework of the card-reading device 1, the first slot S1 electrically connects to the first switch unit SW1 when the first memory card M1 is inserted into the first slot S1, and then the reading unit 12 is able to directly access the first memory card M1 through the first switch unit SW1, in the meantime, when other memory cards (M2, M3, Mn) are respectively inserted into the corresponding slots (S2, S3, Sn) thereof, the slots electrically connecting to the corresponding switch units (SW2, SW3, SWn) thereof, such that the reading unit 12 can still directly access the first memory card M1, and the micro unit 14 is able to access the memory cards except the first memory card M1.

Continuously referring to FIG. 4, the reading unit 12 is connected to the computer 2 through the connecting unit 11, and the micro control unit 14 is communicates with the computer 2 through the reading unit 12. After the first memory card M1 is inserted into the first slot S1, the first switch unit SW1 switches for connecting the first slot S1 to the reading unit 12, so that the user can operate the computer 2 and access the first memory card M1 by means of the reading unit 12. Furthermore, when the first memory card M1 is still inserted in the first slot S1, meanwhile, if the second memory card M2 is inserted into the second slot S2, and the third memory card M3 as well as the Nth memory card Mn are respectively inserted into the third slot S3 and the Nth slot Sn, the micro control unit 14 is aware of the slots which are not electrically connected to reading unit 12 by way of inquiring, and then through the micro unit 14, the user is able to access the second memory card M2, the third memory card M3 and the Nth memory card Mn.

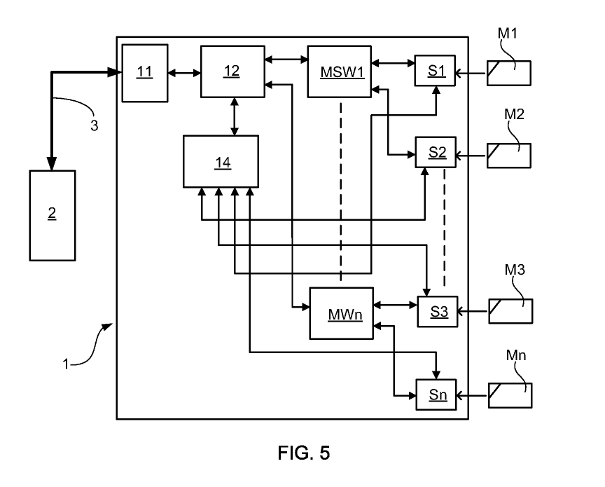

The card-reading device for multiple cards of present invention further has a third practicable framework. Please referring to FIG. 5, which illustrates the third practicable framework of the card-reading device for multi card according to the present invention, as shown in FIG. 5, the third practicable framework of the card-reading device 1 includes: the connecting unit 11, the reading unit 12, the micro control unit 14, a plurality of multi-port switch units (MSW1, MSWn), and the plurality of slots (S1, S2, S3, Sn), wherein the connecting unit 11 is connected to the computer 2 via the transmission line 3, the reading unit 12 is connected to the connecting unit 11, the micro control unit 14 is connected to the reading unit 12, and the plurality of multi-port switch units (MSW1, MSWn) are also connected to the reading unit 12.

Continuously referring to FIG. 5, the plurality of slots (S1, S2, S3, Sn) are respectively connected to the plurality of switch units (MSW1, MSWn) by pair and adapted for inserting the memory cards, moreover, the plurality of slots (S1, S2, S3, Sn) also connecting to the micro control unit 14. In the third practicable framework of the card-reading device 1, the first slot S1 electrically connects to a first multi-port switch unit MSW1 when the first memory card M1 is inserted into the first slot S1, and then the reading unit 12 is able to directly access the first memory card M1 through the first multi-port switch unit MSW1; In the meantime, when other memory cards (M2, M3, Mn) are respectively inserted into the corresponding slots thereof, the slots electrically connecting to the corresponding multi-port switch units thereof (as shown in FIG. 5, the first slot S1 electrically connects to the first multi-port switch unit MSW1, and the third slot S3 electrically connects to a N-th multi-port switch unit MSWn), such that the reading unit 12 can still directly access the first memory card M1, and the micro unit 14 being able to access the memory cards except the first memory card M1.

Moreover, in the third practicable framework of the card-reading device 1, the reading unit 12 is connected to the computer 2 through the connecting unit 11, and the micro control unit 14 is communicates with the computer 2 through the reading unit 12. After the first memory card M1 is inserted into the first slot S1, the first multi-port switch unit MSW1 switches for connecting the first slot S1 to the reading unit 12, so that the user can operate the computer 2 and access the first memory card M1 by means of the reading unit 12. Furthermore, when the first memory card M1 is still inserted in the first slot S1, meanwhile, if the third memory card M3 and the Nth memory card Mn are respectively inserted into the third slot S3 and the Nth slot Sn, the micro control unit 14 is aware of the slots which are not electrically connected to reading unit 12 by way of inquiring, and then through the micro unit 14, the user can access the third memory card M3 and the Nth memory card Mn.

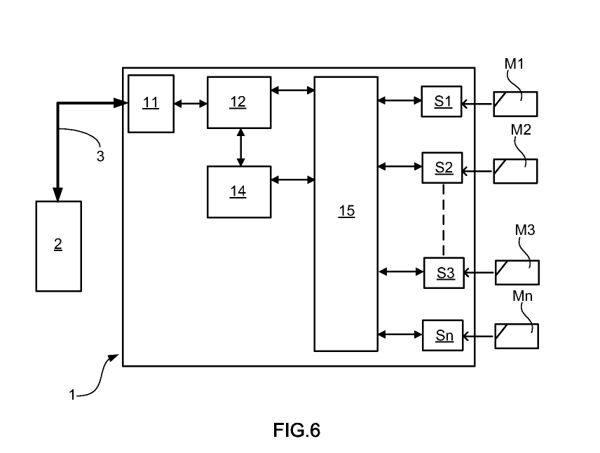

The card-reading device for multiple cards of present invention further has a fourth practicable framework. Please referring to FIG. 6, which illustrates the fourth practicable framework of the card-reading device for multi card according to the present invention, as shown in FIG. 6, the fourth practicable framework of the card-reading device 1 includes: the connecting unit 11, the reading unit 12, the micro control unit 14, a complex programmable logic unit 15, and the plurality of slots (S1, S2, S3, Sn), wherein the connecting unit 11 is connected to the computer 2 via the transmission line 3, reading unit 12 is connected to the connecting unit 11, the micro control unit 14 is connected to the reading unit 12, and the complex programmable logic unit 15 is connected to the reading unit 12 and the micro control unit 14.

In the fourth practicable framework of the card-reading device 1, the plurality of slots (S1, S2, S3, Sn) are connected to the complex programmable logic unit 15 for inserting the memory cards, wherein the first slot S1 electrically connects to the complex programmable logic unit 15 when the first memory card M1 is inserted into the first slot S1, and then the reading unit 12 is able to directly access the first memory card M1 through the complex programmable logic unit 15, in the meantime, when other memory cards (M2, M3, Mn) are respectively inserted into the corresponding slots (S2, S3, Sn) thereof, the slots also electrically connecting to the complex programmable logic unit 15, such that the reading unit 12 can still directly access the first memory card M1, and the micro unit 14 being able to access the memory cards except the first memory card M1 by way of the complex programmable logic unit 15.

Please referring to FIG. 6 again, the micro control unit 14 is communicates with the computer 2 through the reading unit 12. After the first memory card M1 is inserted into the first slot S1, the complex programmable logic unit 15 switches for connecting the first slot S1 to the reading unit 12, so that the user can operate the computer 2 and access the first memory card M1 by means of the reading unit 12. Furthermore, when the first memory card M1 is still inserted in the first slot S1, meanwhile, if the second memory card M2, the third memory card M3 and the Nth memory card Mn are respectively inserted into the second slot S2, the third slot S3 and the Nth slot Sn, trough the complex programmable logic unit 15, the micro control unit 14 is aware of the slots which are not electrically connected to reading unit 12 by way of inquiring, and then by means of the micro unit 14, the user can access the third memory card M3 and the Nth memory card Mn.

Besides, the same to the first practicable framework, the second practicable framework, the third practicable framework and the fourth practicable framework of the card-reading device for multi cards 1, which are not only connected to the computer 2 by the transmission lines 3 but also can be embedded into the computer 2 for accessing the memory cards.

Thus, the card-reading device for multi cards according to the present invention has been disclosed completely and clearly through the first practicable framework, the second practicable framework, the third practicable framework, and the fourth practicable framework. In summary, the present invention has the following advantages:
1. The card reading device has multi slots for inserting multi the same memory cards, so that the user can accessing the memory cards inserted in the slots by means of the reading unit and the micro control unit.
2. The number of the slots in the card-reading device can be made by customization; moreover, the card-reading device has two practicable frameworks for meeting the demands of the different users.

The above description is made on an embodiment of the present invention. However, this embodiment is not intended to limit scope of the present invention, and all equivalent implementations or alterations within the spirit of the present invention still fall within the scope of the present invention.

I claim:

1. A card-reading device for multi cards capable of being inserted a plurality of memory cards, so as to access the plurality of memory cards at the same time, the card-reading device comprising:
a connecting unit, being connected to a computer;
a reading unit, being connected to the connecting unit;
a micro control unit, being connected to the reading unit;
a plurality of switch units, being connected to the reading unit and the micro control unit; and
a plurality of slots, being respectively connected to the plurality of switch units for inserting the memory cards;
wherein a first slot electrically connects to a first switch unit when a first memory card is inserted into the first slot, then the reading unit is able to directly access the first memory card through the first switch unit, in the meantime, when other memory cards are respectively inserted into corresponding slots thereof, the slots electrically connecting to the corresponding switch units thereof, such that the reading unit can still directly access the first memory card, moreover, by way of the other switch unit except the first switch unit, the micro unit being able to access the memory cards except the first memory card.

2. The card-reading device for multi cards of claim 1, wherein the micro control unit is aware of the slots which are not electrically connected to the reading unit by way of the reading unit.

3. The card-reading device for multi cards of claim 1, wherein in the plurality of slots, a second slot being adapted for inserting a second memory card, a third slot being used for inserting a third slot, and a Nth Slot being adapted for inserting a Nth memory card.

4. The card-reading device for multi cards of claim 1, wherein the connecting unit can be connected to the computer via a transmission line.

5. The card-reading device for multi cards of claim 1, which may be embedded in the computer for accessing the memory cards.

6. The card-reading device for multi cards of claim 3, wherein when the first memory card is still inserted in the first slot, in the meantime, after the second memory card is inserted into the second slot as well as the third memory card and the Nth memory card are respectively inserted into the third slot and the Nth slot, through the reading unit, the micro control unit may respectively access the second memory card, the third memory card and the Nth memory card by means of a second switch unit, a third switch unit and a fourth switch unit.

7. A card-reading device for multi cards capable of being inserted a plurality of memory cards, so as to access the plurality of memory cards at the same time, the card-reading device comprising:
a connecting unit, being connected to a computer;
a reading unit, being connected to the connecting unit;
a micro control unit, being connected to the reading unit;
a plurality of switch units, being connected to the reading unit; and
a plurality of slots, being respectively connected to the plurality of switch units for inserting the memory cards, moreover, the plurality of slots also connecting to the micro control unit;
wherein a first slot electrically connects to a first switch unit when a first memory card is inserted into the first slot, and then the reading unit is able to directly access the first memory card through the first switch unit, in the meantime, when other memory cards are respectively inserted into the corresponding slots thereof, the slots electrically connecting to the corresponding switch units thereof, such that the reading unit can still directly access the first memory card, and the micro unit being able to access the memory cards except the first memory card.

8. The card-reading device for multi cards of claim 7, wherein the micro control unit is aware of which slots are not electrically connected to the reading unit by way of inquiring.

9. The card-reading device for multi cards of claim 7, wherein in the plurality of slots, a second slot being adapted for inserting a second memory card, a third slot being used for inserting a third slot, and a Nth Slot being adapted for inserting a Nth memory card.

10. The card-reading device for multi cards capable of claim 7, wherein the connecting unit can be connected to the computer through a transmission line.

11. The card-reading device for multi cards of claim 7, which may be embedded in the computer for accessing the memory cards.

12. The card-reading device for multi cards of claim 9, wherein when the first memory card is still inserted in the first slot, meanwhile, if the second memory card is inserted into the second slot as well as the third memory card and the Nth memory card are respectively inserted into the third slot and the Nth slot, the micro control unit may access the second memory card, the third memory card and the Nth memory card.

13. A card-reading device for multi cards capable of being inserted a plurality of memory cards, so as to access the plurality of memory cards at the same time, the card-reading device comprising:
a connecting unit, being connected to a computer;
a reading unit, being connected to the connecting unit;
a micro control unit, being connected to the reading unit;
a plurality of multi-port switch units, being connected to the reading unit; and
a plurality of slots, being respectively connected to the plurality of switch units by pair and adapted for inserting the memory cards, moreover, the plurality of slots also connecting to the micro control unit;
wherein a first slot electrically connects to a first multi-port switch unit when a first memory card is inserted into the first slot, then the reading unit is able to directly access the first memory card through the first multi-port switch unit, in the meantime, when other memory cards are respectively inserted into the corresponding slots thereof, the slots electrically connecting to the corresponding multi-port switch units thereof, such that the reading unit can still directly access the first memory card, and the micro unit being able to access the memory cards except the first memory card.

14. The card-reading device for multi cards of claim 13, wherein the micro control unit is aware of which slots are not electrically connected to the reading unit by way of inquiring.

15. The card-reading device for multi cards of claim 13, wherein in the plurality of slots, a second slot being adapted for inserting a second memory card, a third slot being used for inserting a third slot, and a Nth Slot being adapted for inserting a Nth memory card.

16. The card-reading device for multi cards capable of claim 13, wherein the connecting unit can be connected to the computer through a transmission line.

17. The card-reading device for multi cards of claim 13, which may be embedded in the computer for accessing the memory cards.

18. The card-reading device for multi cards of claim 15, wherein when the first memory card is still inserted in the first slot, meanwhile, if the third memory card and the Nth memory card are respectively inserted into the third slot and the Nth slot, the third slot and the Nth slot electrically connecting to a second multi-port switch unit, then the micro control unit may access the third memory card and the Nth memory card.

19. A card-reading device for multi cards capable of being inserted a plurality of memory cards, so as to access the plurality of memory cards at the same time, the card-reading device comprising:
a connecting unit, being connected to a computer;
a reading unit, being connected to the connecting unit;
a micro control unit, being connected to the reading unit;
a complex programmable logic unit, being connected to the reading unit and the micro control unit; and
a plurality of slots, being connected to the complex programmable logic unit for inserting the memory cards;
wherein a first slot electrically connects to the complex programmable logic unit when a first memory card is inserted into the first slot, then the reading unit is able to directly access the first memory card through the complex programmable logic unit, in the meantime, when other memory cards are respectively inserted into the corresponding slots thereof, the slots also electrically connecting to the complex programmable logic unit, such that the reading unit can still directly access the first memory card, and the micro unit being able to access the memory cards except the first memory card by way of the complex programmable logic unit.

20. The card-reading device for multi cards of claim 19, wherein the micro control unit is aware of which slots are not electrically connected to the reading unit by way of inquiring.

21. The card-reading device for multi cards of claim 19, wherein in the plurality of slots, a second slot being adapted for inserting a second memory card, a third slot being used for inserting a third slot, and a Nth Slot being adapted for inserting a Nth memory card.

22. The card-reading device for multi cards capable of claim 19, wherein the connecting unit can be connected to the computer through a transmission line.

23. The card-reading device for multi cards of claim 19, which may be embedded in the computer for accessing the memory cards.

24. The card-reading device for multi cards of claim 21, wherein when the first memory card is still inserted in the first slot, meanwhile, if the second memory card is inserted into the second slot as well as the third memory card and the Nth memory card are respectively inserted into the third slot and the Nth slot, the micro control unit may access the second memory card, the third memory card and the Nth memory card by way of the complex programmable logic unit 15.
